(19) United States
(12) Patent Application Publication
(10) Pub. No.: US 2006/0213755 A1
(43) Pub. Date: Sep. 28, 2006

(54) Radio frequency wireless steering wheel

(75) Inventors: Chia-Jung Chang, Kuei San (TW); Chien-Li Lo, Kuei San (TW); Yuan-Ying Yu, Kuei San (TW); Ming Yeh, Kuei San (TW)

Correspondence Address: BIRCH STEWART KOLASCH & BIRCH, PO BOX 747, FALLS CHURCH, VA, 22040-0747, US

(73) Assignee: DELTA ELECTRONICS, INC.

(21) Appl. No.: 11/346,171

(22) Filed: Feb. 3, 2006

(30) Foreign Application Priority Data
Mar. 25, 2005 (TW) 94109467

(51) Int. Cl. H01H 9/00

(52) U.S. Cl. 200/61.54; 340/825.69

(57) ABSTRACT

A radio frequency (RF) wireless steering wheel is disclosed, which is suitable for an automobile. The radio frequency wireless steering wheel comprises: a steering wheel body having an operation panel; a plurality of keys set in the operation panel; a radio frequency signal transmitting installed in the steering wheel body, wherein the radio frequency signal transmitting module can be triggered by the keys module; and a radio frequency signal receiving module installed within the automobile and used to receive the signal transmitted from the radio frequency signal transmitting module, wherein the radio frequency signal receiving module is electrically connected to electronic devices of the automobile. Therefore, the electronic devices of the automobile can be controlled respectively through the keys, the radio frequency signal transmitting module and the radio frequency signal receiving module.

### RELATED APPLICATIONS

The present application is based on, and claims priority from, Taiwan Application Serial Number 94109467, filed Mar. 25, 2005, the disclosure of which is hereby incorporated by reference herein in its entirety.

### FIELD OF THE INVENTION

The present invention relates to a steering wheel of an automobile, and more particularly, to a radio frequency (RF) wireless steering wheel of an automobile.

### BACKGROUND OF THE INVENTION

As electronic systems of automobiles advance, the number of switches and keys of operation interfaces of electronic devices in the automobile increase. For conveniently operating the keys 104 of the electronic devices, the keys 104 are typically installed in a panel 102 of a steering wheel 100, such as shown in FIG. 1.

As the amount of the keys 104 set in the steering wheel 100 increase, the amount of signal wires 106 of the electronic devices connected to the operation panel 102 of the steering wheel 100 increase. These signal wires 106 are usually bundled together. When the steering wheel 100 rotates, the signal wires 106 are severely twisted and may break. Currently, in order to prevent the signal wires 106 from being broken, a ribbon wire composed of the signal wires 106 is scrolled to form dozens of furls that are enclosed in a rotatable wire bundle apparatus 108 of a steering column (not shown) of the steering wheel 100, wherein one end of the rotatable wire bundle apparatus 108 may be connected to the steering wheel 100 and the other end of the rotatable wire bundle apparatus 108 may be connected to the fixed steering column.

However, as the amount of the signal wires 106 is increased, the volume of the signal wire bundle becomes larger, and the size of the rotatable wire bundle apparatus 108 is increased, so that the design difficulty of the steering wheel mechanism is increased, the volume of the steering wheel mechanism is increased, and the manufacturing cost of the rotatable wire bundle apparatus 108 is increased.

### SUMMARY OF THE INVENTION

One objective of the present invention is to provide a radio frequency wireless steering wheel, which uses radio frequency to control electronic devices in an automobile, thereby simplifying the transmission mechanism between a control interface of the steering wheel and the electronic devices. As a result, the weight of the steering wheel can be lightened, the volume of the steering column can be reduced, and the cost of the steering wheel can be lowered.

Another objective of the present invention is to provide a radio frequency wireless steering wheel, which can replace the original signal wire bundle between a control interface of the steering wheel and the controlled electronic devices, thereby freeing the rotation of the steering wheel from being effected by the signal wires and preventing the signal wire bundle from being broken by excessive rotation of the steering wheel and causing poor transmission of the control signals.

According to the aforementioned objectives, the present invention provides a radio frequency wireless steering wheel, which is suitable for an automobile, wherein the automobile includes several electronic devices set therein. The radio frequency wireless steering wheel comprises: a steering wheel body, a plurality of keys, a radio frequency signal transmitting module and a radio frequency signal receiving module. The steering wheel body has an operation panel, and the keys are set in the operation panel. The radio frequency signal transmitting module is installed in the steering wheel body, in which the radio frequency signal transmitting module can be triggered by the keys. The radio frequency signal receiving module is installed within the automobile, and is used to receive the signal transmitted from the radio frequency signal transmitting module, in which the radio frequency signal receiving module is electrically connected to the electronic devices to respectively control the electronic devices in the automobile.

According to a preferred embodiment of the present invention, the radio frequency signal transmitting module has a common supply with the horn of the automobile, and the frequency of the transmitted signal may be 315 MHz or 433 MHz.

By using the radio frequency transmitting method to operate and control the electronic devices in the automobile, the signal wires can be eliminated and the costly rotatable wire bundle box is not needed, thereby greatly reducing the manufacturing cost and effectively decreasing the whole volume of the steering wheel apparatus.

### BRIEF DESCRIPTION OF THE DRAWINGS

The foregoing aspects and many of the attendant advantages of this invention are more readily appreciated as the same become better understood by reference to the following detailed description, when taken in conjunction with the accompanying drawings, wherein:

FIG. 1 illustrates a front view of a conventional steering wheel;

FIG. 2 is a schematic diagram showing another conventional steering wheel; and

FIG. 3 is a schematic diagram showing a radio frequency wireless steering wheel in accordance with a preferred embodiment of the present invention.

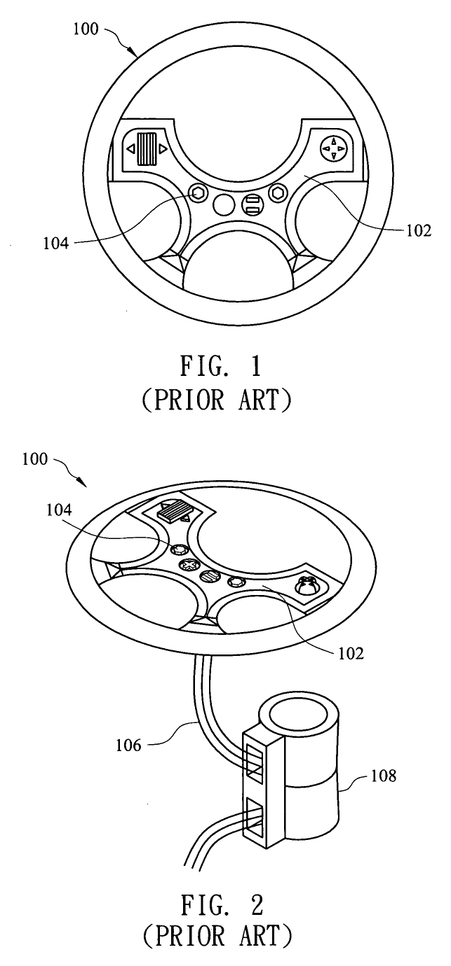

### DETAILED DESCRIPTION OF THE PREFERRED EMBODIMENT

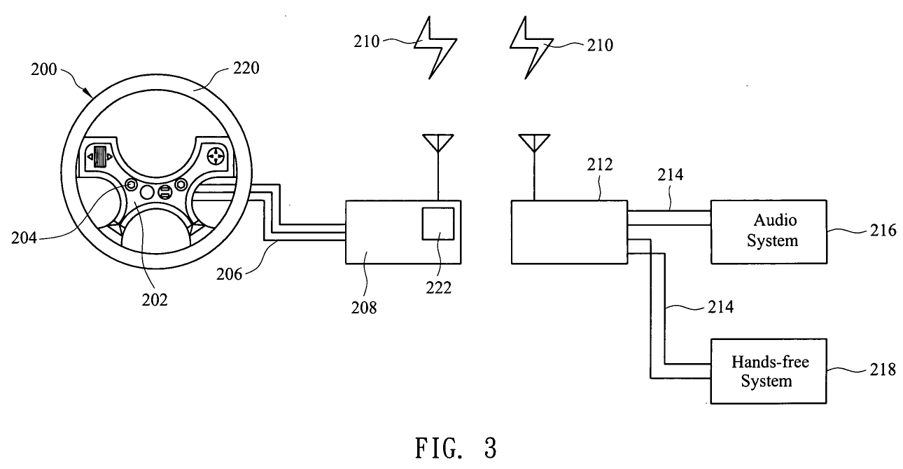

The present invention discloses a radio frequency wireless steering wheel, which uses a radio frequency wireless transmission method to control the various functions of the electronic devices in the automobile, so it can simplify the transmission mechanism between the operation interface of the steering wheel and the electronic devices, can reduce the cost of the steering wheel, and can add convenience to installing the steering wheel apparatus. In order to make the illustration of the present invention more explicit, the following description is stated with reference to FIG. 3.

FIG. 3 is a schematic diagram showing a radio frequency wireless steering wheel in accordance with a preferred embodiment of the present invention. The radio frequency wireless steering wheel 200 can be applied in various automobiles, such as sedans, wagons or trucks. The radio frequency wireless steering wheel 200 mainly comprises a steering wheel body 220, a plurality of keys 204 for controlling various electronic devices in the automobile, a radio frequency signal transmitting module 208 and a radio frequency signal receiving module 212. An upper wheel surface of the steering wheel body 220 has an operation panel 202, and the keys 204 are set in the operation panel 202. The keys 204 are used to control and operate the switch and adjust various functions of various electronic devices in the automobile respectively, such as an audio system 216 and a hands-free system 218 shown in FIG. 3, an air conditioner, power windows, power seats or a satellite navigation device. The keys 204 are electrically connected to the radio frequency signal transmitting module 208 through a plurality of wires 206 respectively.

The radio frequency signal transmitting module 208 comprises a wireless circuit board 222, wherein the frequency of the transmitted signal may be 315 MHz or 433 MHz. The wireless circuit board 222 may include a processor and a transmitting module, wherein the processor can determine the signals transmitted from the operation panel 202 and make the transmitting module emit the signal 210. When the key 204 is pressed, the key 204 can actuate the wireless circuit board 222 of the radio frequency signal transmitting module 208 through the corresponding wire 206. In a preferred embodiment of the present invention, the radio frequency signal transmitting module 208 is installed in the interior of the steering wheel body 220. However, it is understood that the radio frequency signal transmitting module 208 of the present invention may also be installed on the exterior of the steering wheel body 220. The radio frequency signal transmitting module 208 preferably has a common supply with the horn module, which is originally installed in the steering wheel body 220. Typically, the supply specifications of the horn module are 12 V or 24 V.

One feature of the present embodiment is that because the radio frequency signal transmitting module of the present invention and the horn module originally set in the interior of the steering wheel can have a common supply, so an additional supply is not needed for the radio frequency signal transmitting module.

It should be noted that a battery container can also be set in the radio frequency signal transmitting module, wherein the battery set composed of the battery container and at least one battery supplies power to the radio frequency signal transmitting module 208. The battery box comprises a lid and a battery slot, wherein the lid is preferably exposed at a surface of the steering wheel body 220. More preferably, a display element showing the battery status is installed in the lid of the battery box for a user to monitor. When the user notices that the battery needs to be replaced, the user can open the lid of the battery box, remove the dead battery, put a charged battery into the battery box, and close the lid of the battery box to complete the exchange of the battery. Accordingly, using battery power to supply power to the radio frequency signal transmitting module 208 is also very convenient.

The radio frequency signal receiving module 212 is used to receive the radio frequency signal transmitted from the radio frequency signal transmitting module 208. Because the radio frequency signal receiving module 212 is used to receive the radio frequency signal, the radio frequency signal receiving module 212 installed anywhere inside the automobile can receive the signal transmitted by the radio frequency signal transmitting module 208. The radio frequency signal receiving module 212 can be electrically connected to the electronic devices respectively controlled by the keys 204, such as an audio system 216 and a hands-free system 218, through wires 214 respectively. Because the radio frequency signal receiving module 212 inside the automobile can receive the signal 210 transmitted by the radio frequency signal transmitting module 208, the installation location of the radio frequency signal receiving module 212 may be determined according to the wiring convenience between the radio frequency signal receiving module 212 and the controlled electronic devices.

The main feature of the present invention is that because the radio frequency wireless transmission technique is used to replace the signal wires originally set between the operation interface of the steering wheel and the electronic devices inside the automobile, the mechanism of the steering wheel apparatus can be simplified to reduce the volume of the steering wheel apparatus.

In practice, when the driver presses the key 204 on the operation panel 202 of the steering wheel body 220, a control signal is transmitted to the wireless circuit board 222 of the radio frequency signal transmitting module 208 inside the steering wheel body 220 through the wire 206 corresponding to the key 204. The processor of the wireless circuit board 222 firstly determines the received control signal and then commands the radio frequency signal transmitting module 208 to transmit a signal 210. Next, the radio frequency signal receiving module 212 inside the automobile receives the signal transmitted by the radio frequency signal transmitting module 208, converts the received signal 210, and then drives the switch or the adjusts various functions of the controlled electronic device, such as the audio system 216 or the hands-free system 218, through the corresponding wire 214.

According to the aforementioned description, one advantage of the present invention is that the present radio frequency wireless steering wheel uses wireless radio frequency to control the electronic devices inside the automobile, so that the original signal wire bundle can be replaced, such that the costly rotatable wire bundle apparatus is not needed, thereby simplifying the transmission mechanism between the operation panel of the steering wheel and the electronic devices. Therefore, with the application of the radio frequency wireless steering wheel of the present invention, the weight of the steering wheel can be greatly lightened, the volume of the steering column of the steering wheel can be reduced, and the objective of reducing the cost of the steering wheel can be achieved.

According to the aforementioned description, another advantage of the present invention is that the application of the present radio frequency wireless steering wheel can eliminate the original signal wire bundle between the operation panel of the steering wheel and the electronic devices, which can free the rotation of the steering wheel from being effected by the signal wire bundle and can prevent the signal wire bundle from being broken by the excessive rotation of the steering wheel, preventing poor transmission of the control signals from occurring. Therefore, the present radio frequency wireless steering wheel can ensure the signal transmission reliability between the operation panel of the steering wheel and the electronic devices, can decrease the consumption of the transmission apparatus, and can enhance the wiring convenience of the wires of the electronic devices inside the automobile.

As is understood by a person skilled in the art, the foregoing preferred embodiments of the present invention are illustrated of the present invention rather than limiting of the present invention. It is intended that various modifications and similar arrangements included within the spirit and scope of the appended claims are covered, the scope of which should be accorded the broadest interpretation so as to encompass all such modifications and similar structure.

What is claimed is:

1. A radio frequency (RF) wireless steering wheel suitable for an automobile, wherein the automobile includes a plurality of electronic devices set therein, and the radio frequency wireless steering wheel comprises:
a steering wheel body having an operation panel;
a plurality of keys set in the operation panel of the steering wheel body;
a radio frequency signal transmitting module installed in the steering wheel body, wherein the radio frequency signal transmitting module is triggered by the keys; and
a radio frequency signal receiving module installed within the automobile to receive a signal transmitted from the radio frequency signal transmitting module, wherein the radio frequency signal receiving module is electrically connected to the electronic devices to respectively control the electronic devices in the automobile.

2. The radio frequency wireless steering wheel according to claim 1, wherein the automobile further comprises at least one horn, and the horn and the radio frequency signal transmitting module have a common power supply.

3. The radio frequency wireless steering wheel according to claim 1, wherein the radio frequency signal transmitting module comprises a battery set used to supply power.

4. The radio frequency wireless steering wheel according to claim 3, wherein the battery set comprises at least one battery and a battery box.

5. The radio frequency wireless steering wheel according to claim 4, wherein the battery box comprises a lid and a battery slot, and the lid is deposed in a surface of the steering wheel body, wherein the lid further includes a display element for showing a battery status.

6. The radio frequency wireless steering wheel according to claim 1, wherein the electronic devices are selected from the group consisting of an audio system, an air conditioner, power windows, power seats, a hands-free system, and a satellite navigation system.

7. The radio frequency wireless steering wheel according to claim 1, wherein the radio frequency signal transmitting module comprises a wireless circuit board, and the keys can trigger the wireless circuit board.

8. The radio frequency wireless steering wheel according to claim 1, wherein a transmitting signal frequency of the radio frequency signal transmitting module is 315 MHz.

9. The radio frequency wireless steering wheel according to claim 1, wherein a transmitting signal frequency of the radio frequency signal transmitting module is 433 MHz.

10. A radio frequency wireless steering wheel suitable for an automobile, wherein the automobile includes a plurality of electronic devices set therein, and the radio frequency wireless steering wheel comprises:
a steering wheel body having an operation panel;
a plurality of keys set in the operation panel of the steering wheel body;
a radio frequency signal transmitting module installed in the steering wheel body, wherein the radio frequency signal transmitting module comprises a wireless circuit board, the keys trigger the wireless circuit board, and a transmitting signal frequency of the wireless circuit board is 315 MHz or 433 MHz; and
a radio frequency signal receiving module installed within the automobile to receive a signal transmitted from the radio frequency signal transmitting module, wherein the radio frequency signal receiving module is electrically connected to the electronic devices to respectively control the electronic devices in the automobile.

11. The radio frequency wireless steering wheel according to claim 10, wherein the automobile further comprises at least one horn, and the horn and the radio frequency signal transmitting module have a common power supply.

12. The radio frequency wireless steering wheel according to claim 10, wherein the radio frequency signal transmitting module comprises a battery set used to supply power.

13. The radio frequency wireless steering wheel according to claim 12, wherein the battery set comprises at least one battery and a battery box.

14. The radio frequency wireless steering wheel according to claim 13, wherein the battery box comprises a lid and a battery slot, and the lid is deposed in a surface of the steering wheel body, wherein the lid further includes a display element for showing a battery status.

15. The radio frequency wireless steering wheel according to claim 10, wherein the electronic devices are selected from the group consisting of an audio system, an air conditioner, power windows, power seats, a hands-free system, and a satellite navigation system.
